(19) United States
(12) Patent Application Publication
(10) Pub. No.: US 2018/0090843 A1
(43) Pub. Date: Mar. 29, 2018

(54) PATCH ANTENNA CONSTRUCTION

(71) Applicant: TAOGLAS GROUP HOLDINGS LIMITED, Enniscorthy (IE)

(72) Inventor: Christopher M. ANDERSON, Minneapolis, MN (US)

(21) Appl. No.: 15/705,564

(22) Filed: Sep. 15, 2017

Related U.S. Application Data
(60) Provisional application No. 62/399,839, filed on Sep. 26, 2016.

(51) Int. Cl. H01Q 9/04; H01Q 1/38; H01Q 21/00

(52) U.S. Cl. CPC H01Q 9/0457; H01Q 21/0087; H01Q 21/0006; H01Q 1/38

(57) ABSTRACT

Disclosed are patch antennas and methods of patch antenna construction. The disclosed patch antennas comprise three primary elements: a dielectric body, a radiating patch element (radiator plate, radiating element or resonating element), and a feed pin. To assemble an antenna, the radiator plate is press-fit into the dielectric body so that mating features and the apertures in each align. A feed pin is then passed through the aligned apertures. Additional securement of the radiator plate and/or feed pin may be provided by adhesive or mechanical means. Thus, the manufacturing process is simplified and provides more consistent results and reduced costs compared to current methods commonly employed.

### CROSS-REFERENCE

This application claims the benefit of U.S. Provisional Application No. 62/399,839, filed Sep. 26, 2016, entitled Patch Antenna Construction, which application is incorporated herein by reference.

### BACKGROUND

Field: The present disclosure relates in general to an antenna and, in particular, to patch antennas and construction of patch antennas.

Background: As wireless communications technology progressed, devices such as mobile phones, global positioning system (GPS) receivers, etc., became ever more prevalent, driving the development of better-performing, more reliable and less expensive antenna technologies. Patch antennas, because of their robustness, performance and relatively low cost, have emerged as a favored solution in many applications. Next-generation communications technologies, such as Internet-of-Things (IoT), Machine-to-Machine (M2M) communications, tracking devices, fleet telematics, and automotive applications, will only increase this trend.

In typical patch antenna designs, the top-side radiating element comprises a metal paste applied to the dielectric substrate via a screen-printing method. Unless printed in singly or in small runs, the location of the printing on the surface of each element varies from unit to unit. This, in turn, necessitates per-unit tuning, which drives up costs and may have negative effects on antenna precision and consistency of performance. What is needed is a method of construction for patch antennas that eliminates per-unit tuning, simplifying manufacture, delivering more consistent performance and reducing costs and resulting patch antennas.

### SUMMARY

Disclosed are patch antennas and methods of patch antenna construction. The disclosed patch antennas comprise three primary elements: a dielectric body, a radiating patch element (radiator plate), and a feed pin. The dielectric body contains one or more physical features matching one or more mating physical features of the radiator plate. These mating features provide correct alignment and securement of the radiator plate with respect to the dielectric body. The dielectric body and the radiator plate each contain central aperture. To assemble an antenna, the radiator plate is press-fit into the dielectric body so that the mating features and the apertures in each align. A feed pin is then passed through the aligned apertures, which enables the antenna to connect to external elements, for example, electronic components, systems, and/or communication devices. Additional securement of the radiator plate and/or feed pin may be provided by adhesive or mechanical means. Thus the manufacturing process is simplified and provides more consistent results and reduced costs compared to currently employed methods. The patch antenna can also include a plurality of pins, such as 2, 3 or 4 pins.

An additional embodiment includes features protruding upward from the dielectric body to engage with physical features of a radiator plate, such as sides, corners or apertures, thus ensuring alignment of the radiator plate relative to the dielectric body.

The disclosed configuration of the patch antennas also provide for ease of assembly by allow for press-fit without manual soldering. This achieves faster production at a lower cost. Additionally, stronger mechanical shock properties are achieves as well as resistance to temperature changes. The press-fit assembly is particularly suitable when plastic materials are used that might otherwise melt if reflow soldering was used at high temperature.

An aspect of the disclosure is directed to patch antennas. Suitable patch antennas comprise a radiating element constructed of a conductive material having a top surface and a bottom surface with a radiating element aperture positioned symmetrically off-center within the radiating element; a dielectric substrate having a planar surface engaging at least one surface of the radiating element and a dielectric substrate aperture positioned symmetrically off-center wherein the dielectric substrate is configured to securely engage the radiating element so that the dielectric substrate aperture aligns with the radiating element aperture; a conductive feed pin having a head and a shank; wherein the shank of the conductive feed pin passes through the radiating element aperture and the dielectric substrate aperture from a feeding point on the radiating element. The radiating element can be secured to the dielectric substrate via a friction fit or an interference fit. Additionally, the radiating element can be secured to the dielectric substrate via adhesive bonding. In some configurations, the conductive feed pin is secured to at least one of the radiating element and the dielectric substrate via adhesive bonding. The conductive feed pin can be secured to the radiating element and the dielectric substrate via mechanical fastening. One or more additional conductive feed pins can also be included. The dielectric substrate can be plastic. The patch antenna resonating element is round, oval, ovoid, square, or rectangular.

Another aspect of the disclosure is directed to methods of constructing or manufacturing a patch antenna. Suitable methods include the steps of: stamping or precision cutting a radiating element; placing the radiating element constructed of conductive material having a top surface and a bottom surface with a radiating element aperture positioned symmetrically off-center therein onto a dielectric substrate having a planar surface and a dielectric substrate aperture positioned symmetrically off-center; aligning the radiating element aperture with the dielectric substrate aperture; securing the radiating element to the dielectric substrate; and passing a conductive feed pin through the radiating element aperture and the dielectric substrate aperture. The step of securing the radiating element can be achieved via friction fit or interference fit. In some aspects, the step of securing the radiating element can be achieved via adhesive bonding. Other aspects include a combination of friction/interference fit and bonding. Additionally, the step of securing the feed pin can be achieved via adhesive bonding, friction/interference, or a combination thereof. Additionally, step of securing the feed pin can include mechanical fastening. In some configurations, the dielectric substrate is plastic. The patch antenna and/or resonating element can be round, oval, ovoid, square, or rectangular.

Yet another aspect of the disclosure is directed to patch antenna systems. Suitable patch antenna systems comprises a first and a second patch antennas comprising a radiating element constructed of a conductive material having a top surface and a bottom surface with a radiating element aperture positioned symmetrically off-center within the radiating element; a dielectric substrate having a planar surface engaging at least one surface of the radiating element and a dielectric substrate aperture positioned symmetrically off-center wherein the dielectric substrate is configured to securely engage the radiating element so that the dielectric substrate aperture aligns with the radiating element aperture; a conductive feed pin having a head and a shank; wherein the shank of the conductive feed pin passes through the radiating element aperture and the dielectric substrate aperture from a feeding point on the radiating element, wherein the first patch antenna comprises a second conductive feed pin for engaging the second patch antenna.

### INCORPORATION BY REFERENCE

All publications, patents, and patent applications mentioned in this specification are herein incorporated by reference to the same extent as if each individual publication, patent, or patent application was specifically and individually indicated to be incorporated by reference. See, for example:

U.S. Pat. No. 5,155,493 A issued Oct. 13, 1992 to Thursby et al. for Tape type microstrip patch antenna;

U.S. Pat. No. 5,210,542 A issued on May 11, 1993, to Pett, et al., for Microstrip patch antenna structure;

U.S. Pat. No. 5,382,959 A issued Jan. 17, 1995 to Pett et al. for Broadband circular polarization antenna;

U.S. Pat. No. 5,404,145 A issued Apr. 4, 1995 to Sa et al. for Patch coupled aperture array antenna;

U.S. Pat. No. 5,442,366 A issued on Aug. 15, 1995, to Sanford for Raised patch antenna;

U.S. Pat. No. 5,977,710 A issued Nov. 2, 1999, to Kuramoto et al. for Patch antenna and method for making the same;

U.S. Pat. No. 6,211,824 B1 issued on Apr. 3, 2001, to Holden, et al., for Microstrip patch antenna;

U.S. Pat. No. 6,246,368 B1 issued Jun. 12, 2001 to Deming et al., for Microstrip wide band antenna and radome;

U.S. Pat. No. 6,292,143 B1 issued Sep. 18, 2001 to Romanofsky for Multi-mode broadband patch antenna;

U.S. Pat. No. 6,307,509 B1 issued Oct. 23, 2001 to Krantz for Patch antenna with custom dielectric;

U.S. Pat. No. 6,359,588 B1 issued on Mar. 19, 2002, to Kuntzsch for Patch antenna;

U.S. Pat. No. 6,624,787 B2 issued Sep. 23, 2003 to Puzella et al. for Slot coupled, polarized egg-crate radiator;

U.S. Pat. No. 6,879,288 B2 issued Apr. 12, 2005 to Byrne et al. for Interior patch antenna with ground plane assembly;

U.S. Pat. No. 6,911,939 B2 issued Jun. 28, 2005 to Caron et al. for Patch and cavity for producing dual polarization states with controlled RF beamwidths;

U.S. Pat. No. 6,937,192 B2 issued Aug. 30, 2005 to Mendolia et al., for Method for fabrication of miniature lightweight antennas;

U.S. Pat. No. 7,629,928 B2 issued Dec. 8, 2009 to Fabrega-Sanchez et al. for Patch antenna with electromagnetic shield counterpoise;

U.S. Pat. No. 8,174,450 B2 issued May 8, 2012 to Tatarnikov et al. for Broadband micropatch antenna system with reduced sensitivity to multipath reception;

U.S. Pat. No. 8,354,972 B2 issued Jan. 1, 2013 to Borja et al. for Dual-polarized radiating element, dual-band dual-polarized antenna assembly and dual-polarized antenna array;

U.S. Pat. No. 8,378,893 B2 issued Feb. 19, 2013 to Harokopus for Patch antenna; and

U.S. Pat. No. 8,587,480 B2 issued on Nov. 19, 2013, to Kim, et al., for Patch antenna and manufacturing method thereof;

WO 2009/149471 A1 published Dec. 10, 2009, for Broadband antenna with multiple associated patches and coplanar grounding for RFID applications; and

Manesh Passive Patch Antenna—application note (Jun. 4, 2013), APAE Series Low Profile antennas.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is an isometric top view of a patch antenna;

FIG. 1B is a top view of a dielectric body;

FIG. 1C is a top view of a radiator plate;

FIG. 1D is an isometric illustration of a feed pin;

FIG. 1E is a top view of a patch antenna;

FIG. 1F is a side view of a patch antenna;

FIG. 1G is a bottom view of a patch antenna;

FIG. 1H is a section view of a patch antenna;

FIG. 1I is an isometric section view of a patch antenna;

FIG. 2 is an exploded illustration of a patch antenna according to the disclosure;

FIG. 3 is an isometric top view of an alternate configuration of a patch antenna;

FIG. 4 is an isometric top view of an alternate configuration of a patch antenna; and

FIG. 5 is an isometric top view of an alternate configuration of a patch antenna.

### DETAILED DESCRIPTION

Disclosed are patch antennas and methods of construction for patch antennas which comprise: 1) forming of a body of dielectric material with a suitable cavity for a radiator plate or resonating element and an aperture for a feed pin; 2) forming of a radiator plate or resonating element which dimensionally matches the cavity and feed pin aperture in dielectric body; 3) press-fitting a radiator plate or resonating element into dielectric cavity; and 4) installing and securing of the feed pin through radiator plate or resonating element and the dielectric body. The radiator plate or resonating element of the patch antenna may be further secured by a press-fit, interference fit, friction fit, adhesive bonding or by employing the feed pin as a securement mechanism, e.g., as part of a threaded-fastener or friction-fastener assembly, via solder-bonding or through use of conductive epoxy. The patch antenna can also include a plurality of feed pins, such as 2, 3 or 4 pins.

The dielectric body may be formed from any suitable dielectric material which possesses desired properties, including but not limited to ceramics and thermoplastics. The radiator plate may be formed from sheet metal, printed circuit board (PCB) other suitable conductor. In the embodiments disclosed the radiator plate is rectangular in form. In other embodiments, it may take any form and may include one or more notches, slots, and/or apertures.

Because each radiator plate is created individually, e.g., via sheet metal stamping or precision cutting of a PCB element, the exact location of the feed pin relative to the edges of the radiator plate is ensured. Such processes offer high precision and repeatability compared to construction methods currently in use. This negates the need for per-unit tuning, resulting in lower overall manufacturing cost compared to current methods of construction. In addition, by minimizing unit-to-unit variation, the method delivers more robust, repeatable performance, especially in mass-production applications. This makes it an ideal solution for IoT, M2M, tracking, telematics, and automotive applications.

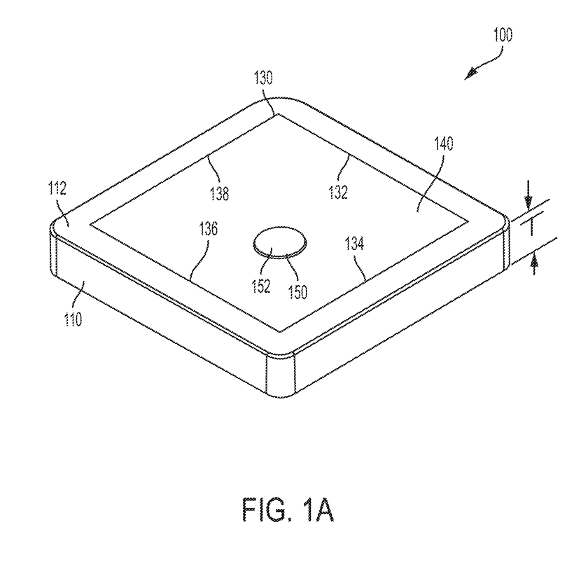

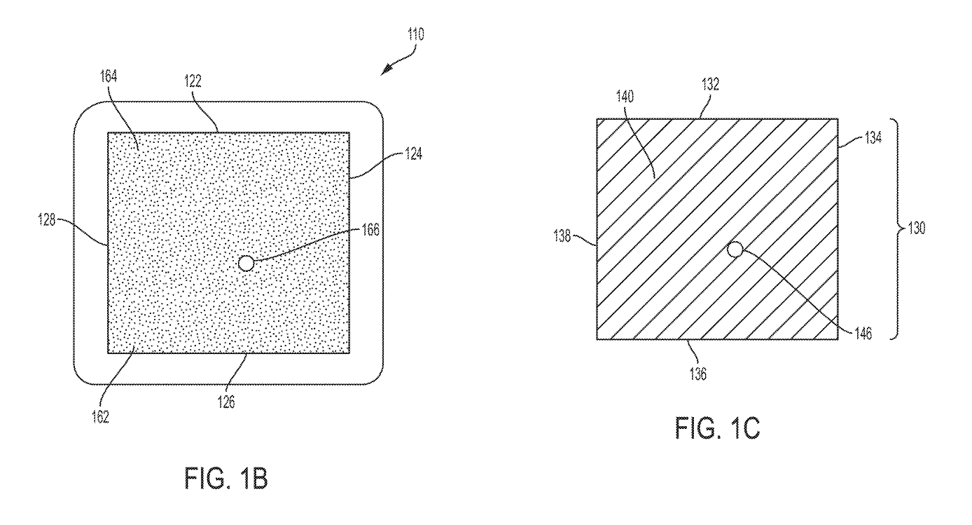

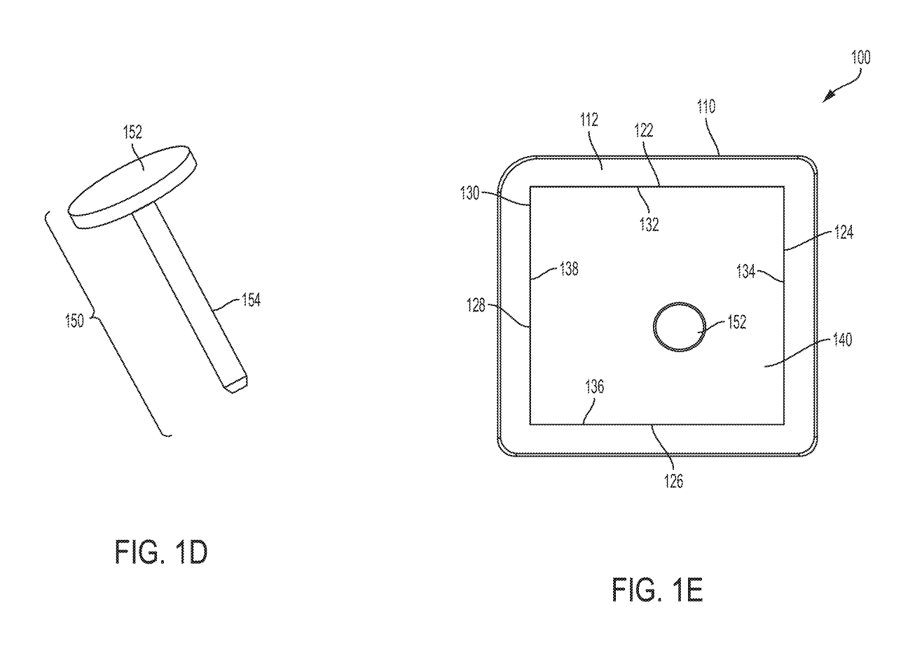

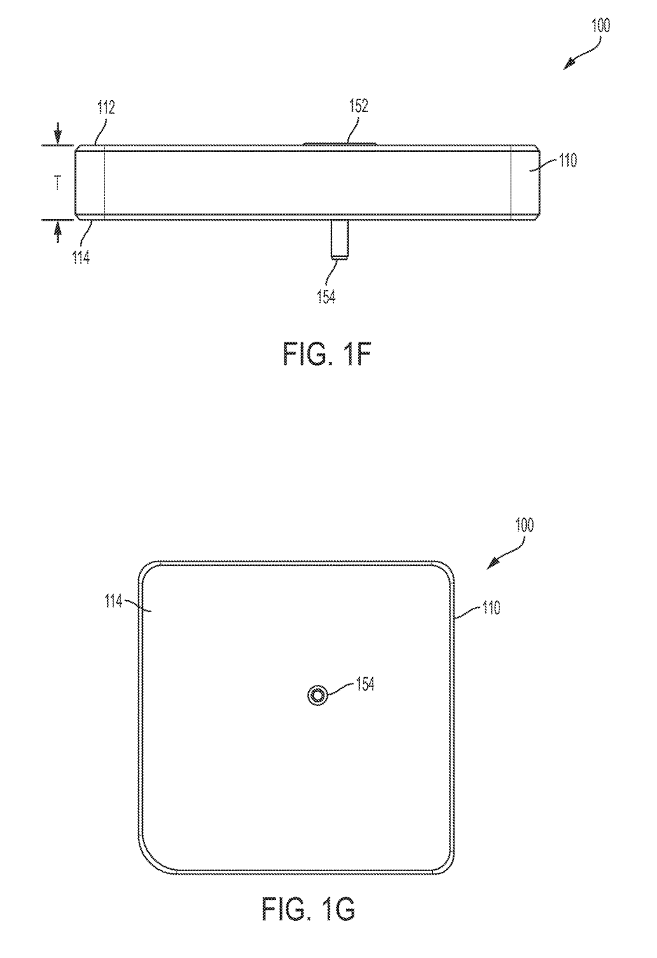

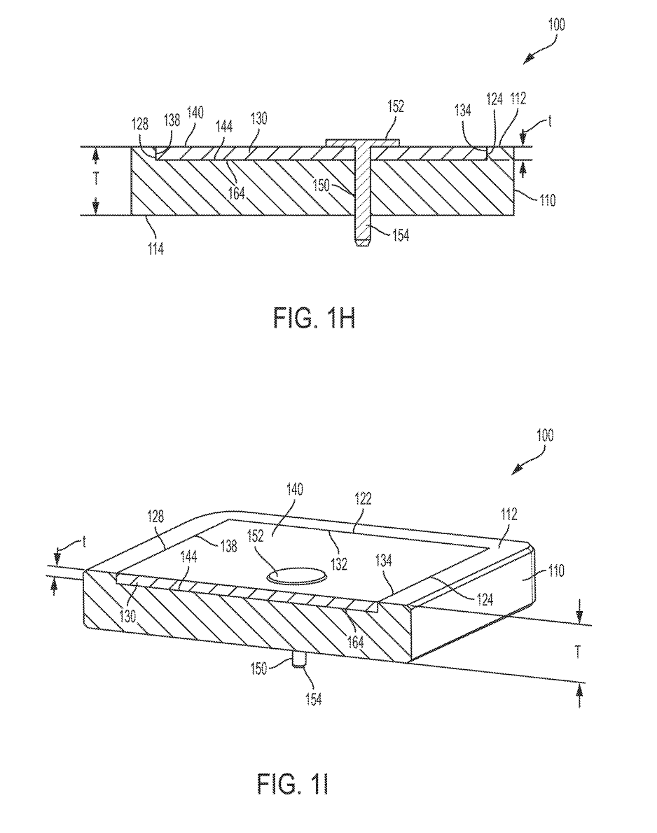

FIG. 1A is an isometric top view of an antenna assembly 100. The antenna assembly 100 comprises three elements: a dielectric body 110, radiator plate 130 (or resonating element) and feed pin 150. Visible in the illustration is the dielectric body 110 which is viewed from a dielectric body top surface 112. A radiator plate 130 with sides 132, 134, 136, 138 is positioned on the dielectric body top surface 112 of the dielectric body 110 or within a recess in the dielectric body. As illustrated, the radiator plate 130 is positioned centrally on the dielectric body top surface 112, with the dielectric body 110 having a length and width greater than the length and width of the radiator plate 130. A feed pin head 152 of a feed pin 150 is visible from the isomeric top view. In the embodiment depicted, dielectric body 110 is rectangular with rounded corners when viewed from the top and of uniform thickness, T. The thickness of the dielectric body 110 is typically greater than the thickness of the radiator plate 130. The dielectric body 110 and the radiator plate 130 do not need to be square, as will be appreciated by those skilled in the art. Additionally, any suitable dielectric material can be used for the dielectric body 110. The overall dimensions of the assembly can vary depending on the implementation. Thus, a wide variety of sizes can be employed without departing from the scope of the disclosure.

FIG. 1B is a top plan view of the dielectric body 110. Centrally located (but not necessarily centered) in the dielectric body 110 is a cavity 162. The cavity 162 can be rectangular in a plan view, as illustrated, and is bounded by a first cavity side 122, a second cavity side 124, a third cavity side 126, and a fourth cavity side 128, numbered clockwise. Cavity 162 is of uniform depth with a depth (d) that is less than the thickness (T) of the dielectric body, d<T. The shaded area in FIG. 1B depicts the cavity bottom surface 164, which is planar and contains cavity aperture 166, which is of circular cross section. The cavity aperture 166 is positionable symmetrically off-center from a center of the dielectric body 110. Positioning the pin off-center, as illustrated, facilitates achieving circular polarization. However, as would be appreciated by those skilled in the art, positioning the pin in another location can be useful for example where linear polarization is desired.

FIG. 1C is a top view of radiator plate 130. Radiator plate 130 is rectangular in plan view, and is bounded by first radiator plate side 132, second radiator plate side 134, third radiator plate side 136, and fourth radiator plate side 138, numbered clockwise. Radiator plate 130 is planar, with radiator plate top surface 140 visible in FIG. 1C. The radiator plate 130 has uniform thickness, t, which can be equal to a depth, d, of the cavity 162 shown in FIG. 1B. To enable press-fit installation of the radiator plate 130 into the cavity 162 of the dielectric body 110, the length of first radiator plate side 132 is substantially the same as length of first cavity side 122; the length of second radiator plate side 134 is substantially the same as length of second cavity side 124; the length of third radiator plate side 136 is substantially the same as length of third cavity side 126; and the length of fourth radiator plate side 138 is substantially the same as length of fourth cavity side 128. Centrally located in the radiator plate 130 is radiator plate aperture 146, which is of circular cross-section of the substantially same diameter as cavity aperture 166 in the cavity bottom surface 164 shown in FIG. 1B. The radiator plate aperture 146 is positioned such that, when the radiator plate 130 is installed in dielectric body 110, a location of the radiator plate aperture 146 coincides with the location of the cavity aperture 166 when viewed from above, enabling installation of a feed pin 150.

FIG. 1D is an isometric view of feed pin 150, showing a feed pin head 152 and a feed pin shank 154. Upon installation of the radiator plate 130 in the dielectric body 110, the feed pin 150 is installed such that the feed pin shank 154 passes through the radiator plate aperture 146 and the cavity aperture 166 so that the feed pin head 152 rests upon the radiator plate top surface 140 and the feed pin shank 154 extends beyond the dielectric body 110, facilitating attachment to external electronics.

FIG. 1E is a top view of an antenna assembly 100, comprising: the dielectric body 110, the radiator plate 130 and the feed pin 150. Visible details of the dielectric body 110 are the dielectric body top surface 112, a first cavity side 122, a second cavity side 124, a third cavity side 126, and a fourth cavity side 128. Visible details of the radiator plate 130 are radiator plate top surface 140, first radiator plate side 132, second radiator plate side 134, third radiator plate side 136, and fourth radiator plate side 138. Also visible is feed pin head 152.

FIG. 1F is a side view of the antenna assembly 100. Visible in the illustration are the dielectric body 110 having a dielectric body top surface 112, and dielectric body bottom surface 114. Of note is the uniform thickness, T, of dielectric body 110. Also visible are feed pin head 152 and the feed pin shank 154 extending beyond dielectric body bottom surface 114. FIG. 1G is a bottom plan view of the antenna assembly 100 showing the dielectric body 110 having a dielectric body bottom surface 114, and the feed pin shank 154.

FIG. 111 is a cross-section view of antenna assembly 100 with: a dielectric body 110, a radiator plate 130 and a feed pin 150. As illustrated, the dielectric body 110 has a dielectric body top surface 112 and a dielectric body bottom surface 114 and is of uniform thickness (T). Also depicted are second cavity side 124, fourth cavity side 128, and cavity bottom surface 164 in the dielectric body 110. A radiator plate 130, of thickness, t<T, whose bottom surface 144 rest upon cavity bottom surface 164; whose top surface 140 is coplanar with dielectric body top surface 112; whose second radiator plate side 134 abuts second cavity side 124; and whose fourth radiator plate side 138 abuts fourth cavity side 128. The thickness t of the radiator plate is substantially the same as the depth of the cavity 162 shown in FIG. 1B. As depicted, the feed pin 150 passes through the radiator plate aperture 146 and the cavity aperture 166 such that the feed pin head 152 rests upon the radiator plate top surface 140 and feed pin shank 154 extends beyond the bottom surface of the dielectric body 110.

FIG. 1I is an isometric section view of antenna assembly 100 with: a dielectric body 110, a radiator plate 130 and a feed pin 150. As illustrated, the dielectric body 110 has a dielectric body top surface 112 and a dielectric body bottom surface 114 and is of uniform thickness, T. Also depicted are the first cavity side 122, second cavity side 124, fourth cavity side 128, and cavity bottom surface 164. The radiator plate 130 is shown positioned within the cavity of the dielectric body 110. The radiator plate 130 has a thickness, t<T. The bottom surface 144 of the radiator plate 130 rest upon cavity bottom surface 164; and the top surface 140 of the radiator plate 130 is coplanar with dielectric body top surface 112. Additionally, the first radiator plate side 132 abuts first cavity side 122; whose second radiator plate side 134 abuts second cavity side 124; and whose fourth radiator plate side 138 abuts fourth cavity side 128. The feed pin 150 passes through radiator plate aperture 146 and cavity aperture 166 such that feed pin head 152 rests upon radiator plate top surface 140 and feed pin shank 154 extends beyond dielectric body 110, facilitating connection to external electronics.

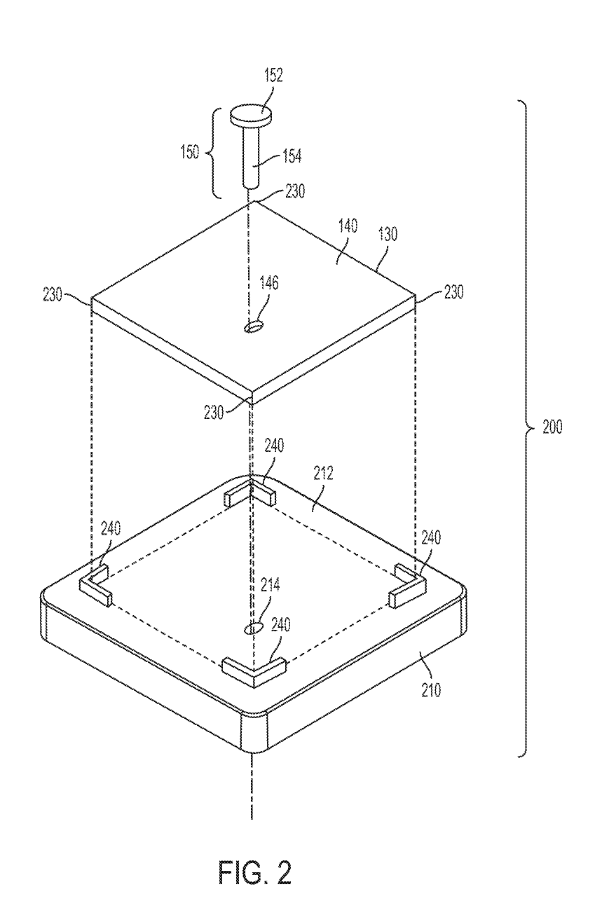

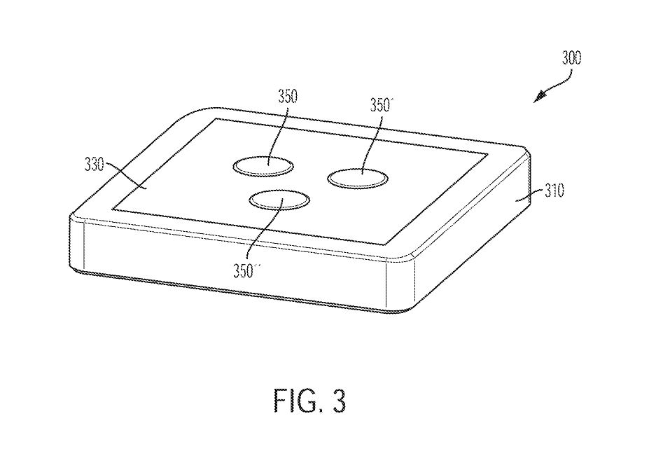

FIG. 2 is an exploded isometric view of an antenna assembly 200 according to the disclosure. Similar to the configuration of FIG. 1, a feed pin 150 with a feed pin head 152 and feed pin shank 154 are provided. Additionally, a radiator plate 130 is provided. Located within the radiator plate 130 is a radiator plate aperture 146. Note that in the embodiment depicted in FIG. 2, the feed pin 150 and the radiator plate 130 are identical in dimension, composition and construction.

Proceeding now to the third element depicted in FIG. 2, the dielectric body 210 has the similar perimeter dimensions and thickness as dielectric body 110 depicted in FIG. 1. The dielectric body top surface 212 is planar or substantially planar. The dielectric body aperture 214 is of circular cross section and lies in the dielectric body 210, providing a path through which the feed pin 150 may pass to connect to external devices, components, and/or electronics.

Rising from the dielectric body top surface 212 are four alignment brackets 240. In the embodiment depicted, the alignment brackets 240 are substantively L-shaped when viewed from above, with equal-length legs, each of which is approximately ⅙ the length of first radiator plate side 132. The height of the alignment brackets 240 is a substantial fraction of the thickness of the radiator plate 130 and may correspond to the thickness of the radiator plate 130. The alignment brackets 240 are positioned so that they engage the corners 230 of the radiator plate 130 when it is placed upon dielectric body 210. The resulting position of radiator plate 130 is centered upon second dielectric body and the radiator plate aperture 146 coincides with the dielectric body aperture 214. In addition to providing correct positioning of the radiator plate 130 upon the dielectric body 210, the engagement of the alignment brackets 240 with the corners 230 of the radiator plate 130 may result in a friction or interference fit, securing the radiator plate 130 to the dielectric body 210.

To complete the construction of the antenna assembly 200, the feed pin 150 passes through the radiator plate aperture 146 and dielectric body aperture 214 such that feed pin head 152 rests upon the radiator plate top surface 140 and the feed pin shank 154 extends through the dielectric body 210, facilitating connection to external electronics. The radiator plate 130 may be further secured to the dielectric body 210 by adhesive bonding or by employing the feed pin 150 as a securement mechanism, e.g., as part of a threaded- or friction-fastener assembly, via solder-bonding or through use of conductive epoxy.

The design of the antenna assembly 200 allows for an ease of assembly by using allowing for press-fit and elimination of manual soldering. The use of press-fit provides an antenna assembly with a stronger mechanical shock properties and resistance to temperature changes. Additionally, using press-fit during the manufacturing process enables the use of a wider range of materials, such as plastic, which are likely to be damaged where soldering is used.

FIG. 3 is an isometric top view of an antenna assembly 300. The antenna assembly 300 comprises three elements: a dielectric body 310, radiator plate 330 (or resonating element) and three feed pins 350. 350′, 350″. Visible in the illustration is the dielectric body 310 which is viewed from a dielectric body top surface. The radiator plate 330 is positioned within a dielectric receiving cavity on the top surface of the dielectric body 310. As illustrated, the radiator plate 330 is positioned centrally on the dielectric body top surface. The feed pin heads of the feed pins 350. 350′, 350″ are visible from the isomeric top view.

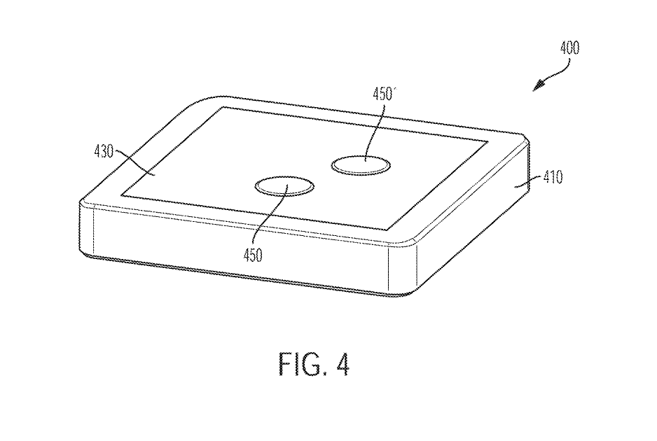

FIG. 4 is an isometric top view of an antenna assembly 400. The antenna assembly 400 comprises three elements: a dielectric body 410, radiator plate 430 (or resonating element) and two feed pins 450, 450′. Visible in the illustration is the dielectric body 410 which is viewed from a dielectric body top surface. The radiator plate 430 is positioned within a dielectric receiving cavity on the top surface of the dielectric body 410. As illustrated, the radiator plate 430 is positioned centrally on the dielectric body top surface. The feed pin heads of the two feed pins 450. 450′ are visible from the isomeric top view.

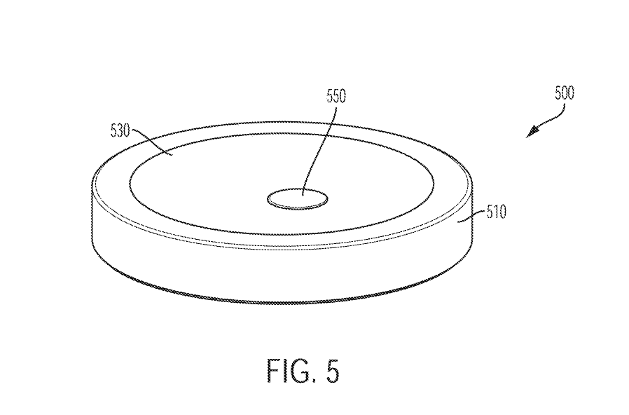

FIG. 5 is an isometric top view of an antenna assembly 500 having a circular form factor The antenna assembly 500 also comprises three elements: a dielectric body 510, radiator plate 530 (or resonating element) and a feed pin 550. Visible in the illustration is the dielectric body 510 which is viewed from a dielectric body top surface. The radiator plate 530 is positioned within a dielectric receiving cavity on the top surface of the dielectric body 510. As illustrated, the radiator plate 530 is positioned centrally on the dielectric body top surface. The feed pin head of the feed pin 550 are visible from the isomeric top view.

Configurations with a dual feed pin, as shown in FIG. 4 allows for independent phase matching of the horizontal and vertical polarizations. The independent phase matching allows for optimal axial ratio and results in improved circular polarization. Additional feed pins, illustrated as three pins in FIG. 3, can be used as a pass-through to a stacked patch that rests on top of a main patch. Thus, for example, a third pin can be a single feed to a patch on top of a dual feed patch. A four pin configuration could provide connection to a dual feed patch on both the top and the bottom.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A patch antenna comprising
a radiating element constructed of a conductive material having a top surface and a bottom surface with a radiating element aperture positioned symmetrically off-center within the radiating element;
a dielectric substrate having a planar surface engaging at least one surface of the radiating element and a dielectric substrate aperture positioned symmetrically off-center wherein the dielectric substrate is configured to securely engage the radiating element so that the dielectric substrate aperture aligns with the radiating element aperture;
a conductive feed pin having a head and a shank;
wherein the shank of the conductive feed pin passes through the radiating element aperture and the dielectric substrate aperture from a feeding point on the radiating element.

2. The patch antenna of claim 1 wherein the radiating element is secured to the dielectric substrate via a friction fit or an interference fit.

3. The patch antenna of claim 1 wherein the radiating element is secured to the dielectric substrate via adhesive bonding.

4. The patch antenna of claim 1 wherein the conductive feed pin is secured to at least one of the radiating element and the dielectric substrate via adhesive bonding.

5. The patch antenna of claim 1 wherein the conductive feed pin is secured to the radiating element and the dielectric substrate via mechanical fastening.

6. The patch antenna of claim 1 further comprising one or more additional conductive feed pins.

7. The patch antenna of claim 1 wherein the dielectric substrate is plastic.

8. The patch antenna of claim 1 wherein the resonating element is round, square, or rectangular.

9. A method of constructing a patch antenna comprising the steps of:
stamping or precision cutting a radiating element;
placing the radiating element constructed of conductive material having a top surface and a bottom surface with a radiating element aperture positioned symmetrically off-center therein onto a dielectric substrate having a planar surface and a dielectric substrate aperture positioned symmetrically off-center;
aligning the radiating element aperture with the dielectric substrate aperture;
securing the radiating element to the dielectric substrate; and
passing a conductive feed pin through the radiating element aperture and the dielectric substrate aperture.

10. The method of claim 9 further comprising the step of securing the radiating element via friction fit or interference fit.

11. The method of claim 9 further comprising the step of securing the radiating element via adhesive bonding.

12. The method of claim 9 further comprising the step of securing the feed pin via adhesive bonding.

13. The method of claim 9 further comprising the step of securing the feed pin via mechanical fastening.

14. The method of claim 9 wherein the dielectric substrate is plastic.

15. The method of claim 9 wherein the resonating element is round, square, or rectangular.

16. A patch antenna system comprising a first patch antenna and a second patch antenna wherein the first patch antenna and the second patch antenna comprise:
a radiating element constructed of a conductive material having a top surface and a bottom surface with a radiating element aperture positioned symmetrically off-center within the radiating element;
a dielectric substrate having a planar surface engaging at least one surface of the radiating element and a dielectric substrate aperture positioned symmetrically off-center wherein the dielectric substrate is configured to securely engage the radiating element so that the dielectric substrate aperture aligns with the radiating element aperture;
a conductive feed pin having a head and a shank; wherein the shank of the conductive feed pin passes through the radiating element aperture and the dielectric substrate aperture from a feeding point on the radiating element,
wherein the first patch antenna comprises a second conductive feed pin for engaging the second patch antenna.
